(19) United States
(12) Patent Application Publication
(10) Pub. No.: US 2025/0376390 A1
(43) Pub. Date: Dec. 11, 2025

(54) METHODS AND APPARATUS FOR REGENERATION OF RESIN FOR WATER PURIFICATION

(71) Applicant: Phibro Tech, Inc., Santa Fe Springs, CA (US)

(72) Inventors: David Clark, Brea, CA (US); Jeremy Rosenfeld, Carlsbad, CA (US)

(73) Assignee: Phibro Tech, Inc., Santa Fe Springs, CA (US)

(21) Appl. No.: 19/234,056

(22) Filed: Jun. 10, 2025

Related U.S. Application Data
(60) Provisional application No. 63/658,388, filed on Jun. 10, 2024.

(51) Int. Cl. C02F 1/42; B01J 39/04; B01J 39/18; B01J 49/06; B01J 49/53; B01J 49/60; B01J 49/85; C02F 1/00; C02F 101/22

(52) U.S. Cl. CPC C02F 1/42; B01J 39/04; B01J 39/18; B01J 49/06; B01J 49/53; B01J 49/60; B01J 49/85; C02F 1/008; C02F 2101/22; C02F 2201/008; C02F 2209/05; C02F 2209/40; C02F 2303/16

(57) ABSTRACT

A system for regenerating ion exchange resin can include a vehicle, a tank coupled to the vehicle and configured to supply brine and receive waste solution, a pump fluidly coupled to the tank and configured to be fluidly coupled to an ion exchange resin of an ion exchange column, a control system configured to control the pump, and one or more sensors configured to measure properties of the brine and/or waste solution and provide data to the control system. The one or more sensors can include a conductivity meter configured to measure the conductivity of the waste solution. The pump can supply brine which is configured to regenerate the ion exchange resin by removing one or more impurities from the ion exchange resin of the ion exchange column. The control system can collect data and use it to adjust system operation.

### CROSS REFERENCE TO RELATED APPLICATION

This application claims the benefit of U.S. Provisional Patent Application No. 63/658,388, filed Jun. 10, 2024, which is incorporated herein by reference.

### FIELD

The present disclosure relates to systems and methods for ion exchange equipment regeneration and waste management.

### BACKGROUND

Hexavalent chromium (Cr(VI)) is a chemical compound that contains the element chromium in the +6 oxidation state. This compound occurs naturally, but is also produced in several industrial processes. Cr(VI) has been identified as carcinogenic and the potential for its presence in well water has been cause for concern. Both federal and state regulations for Cr(VI) in drinking water have been passed. California, for example, currently has a requirement which sets the maximum level for Cr(VI) in drinking water at 10 parts per billion (ppb). Ion exchanger (IX) columns can be used to remove contamination such as Cr(VI) from water extracted from wells. Strong Base Anion (SBA) ion exchange resins can be used in IX columns. However, once the resin becomes saturated with removed contaminants the resin must either be replaced or regenerated. Replacing resin can often be prohibitively expensive. Existing systems for removal of Cr(VI) from resins have several weaknesses such as hazardous waste tanks which can require frequent, sometimes daily, inspections. These tanks may also be subject to requirements to be emptied, in some cases every 90 days. As such, a need exists for improved systems and methods for ion exchange equipment regeneration and waste management.

### SUMMARY

Described herein are systems for ion exchange resin regeneration and waste management and methods of use. The disclosed controllable power supply units can for example provide all of the components required to regenerate the ion exchange resin in an ion exchange column of a water purification system and can be mobile so as to reduce the equipment and costs associated with operating and maintaining an ion exchange column.

In some examples, a system, comprises a vehicle comprising a tank; and a regeneration station comprising one or more components including a pump, valves, and conduits arranged to place the tank on the vehicle in fluid communication with an ion exchange column of a water purification system; wherein the regeneration station is configured to supply a brine from the tank to the ion exchange column and return a liquid waste solution from the ion exchange column to the tank. In some examples, the regeneration station is mounted on the vehicle.

In some examples, the regeneration station further comprises a conductivity meter. In some examples, the conductivity meter is configured to measure the conductivity of the brine supplied to the ion exchange column. In some examples, the conductivity meter is a first conductivity meter, and the system further comprises a second conductivity meter configured to measure the conductivity of the liquid waste solution.

In some examples, the regeneration station comprises a brine/rinse outlet connection configured to place the regeneration station in fluid communication with an inlet of the ion exchange column and wherein the conductivity meter is upstream of the brine/rinse outlet connection. In some examples, the regeneration station further comprises a spent brine return connection configured to place the regeneration station in fluid communication with an outlet of the ion exchange column; the regeneration station further comprises a brine return outlet connection configured to place the regeneration station in fluid communication with the tank; and the second conductivity meter is downstream of the spent brine return connection and upstream of the brine return outlet.

In some examples, the regeneration station further comprises one or more flow meters. In some examples, the regeneration station further comprises a mixer configured to mix site water with brine at a first concentration to result in brine at a second concentration. In some examples, the mixer is downstream of a service water inlet connection configured to connect to site water and downstream of a pump configured to draw brine from the tank. In some examples, the mixer is upstream of and in fluid communication with a brine outlet of the regeneration station, the brine outlet being configured to supply brine at the second concentration to the ion exchange column.

In some examples, the tank is divided into two portions, each portion configured to selectively interface with the regeneration station.

In some examples, the system further comprises a control system configured to control the one or more components of the regeneration station, wherein the control system is configured to receive conductivity data from the conductivity meter and stop a freshwater rinse when a conductivity of water exiting the ion exchange column reaches a predetermined level.

In some examples, the system further comprises an eductor assembly downstream of the brine return outlet.

In some examples, a method comprises transferring brine from a tank coupled to a vehicle to an ion exchange column of a water purification system; flowing the brine through an ion exchange resin of the ion exchange column, wherein the brine regenerates the resin by removing one or more impurities resulting in an aqueous waste solution; controlling a flow rate and/or a concentration of the brine; removing the aqueous waste solution from the ion exchange column; and returning the aqueous waste solution to the tank coupled to the vehicle.

In some examples, the one or more impurities comprises hexavalent chromium. In some examples, the brine comprises a sodium chloride solution. In some examples, the brine in the tank comprises a first brine concentration, and the method further comprises mixing water with the brine at the first brine concentration until the brine comprises a second brine concentration that is lower than the first brine concentration. In some examples, the first brine concentration is in a range of 20% to 26.5% sodium chloride by weight, and wherein the second brine concentration is in a range of 10% to 20% sodium chloride by weight. In some examples, the brine at the second brine concentration is supplied to the ion exchange column.

In some examples, transferring brine from the tank coupled to the vehicle to the ion exchange column comprises transferring the brine with a regeneration station which comprises one or more components including a pump, valves, and conduits arranged to place the tank on the vehicle in fluid communication with an ion exchange column. In some examples, the method further comprises rinsing the resin with fresh water until water exiting the ion exchange column comprises a predetermined conductivity.

The foregoing and other objects, features, and advantages of the disclosed technology will become more apparent from the following detailed description, which proceeds with reference to the accompanying figures.

### BRIEF DESCRIPTION OF THE DRAWINGS

FIGS. 1A-1B are schematic depictions of a system for ion exchange equipment regeneration and waste management.

FIGS. 2A-2C are schematic depictions of the components of the system of FIG. 1 which are installed upon a vehicle and/or at the site.

FIG. 3 is a graph showing conductivity and Cr (VI) content of the waste solution as a function of the number of bed volumes of brine supplied.

FIG. 4 depicts a method of using the system for ion exchange equipment regeneration and waste management.

FIG. 5 is a schematic depiction of the components of the system of FIG. 1 according to another example.

FIGS. 6-11 depict aspects of an exemplary system for regenerating ion exchange resin according to another example.

FIG. 12 is a schematic depiction of components of the system for regenerating ion exchange resin of FIGS. 6-11.

FIG. 13 depicts a method of using a system for ion exchange resin regeneration.

FIGS. 14A-14B are schematic depictions of the components of systems for regenerating ion exchange resin, according to additional examples.

FIG. 15 illustrates a generalized example of a computing environment in which software and control algorithms for the described examples can be implemented.

### DETAILED DESCRIPTION

### General Considerations

The systems and methods described herein, and individual components thereof, should not be construed as being limited to the particular uses or systems described herein in any way. Instead, this disclosure is directed toward all novel and non-obvious features and aspects of the various disclosed embodiments, alone and in various combinations and subcombinations with one another. For example, any features or aspects of the disclosed embodiments can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

As used herein, the term “exemplary” means serving as a non-limiting example, instance, or illustration. As used herein, the terms “e.g.,” and “for example,” introduce a list of one or more non-limiting embodiments, examples, instances, and/or illustrations.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “provide,” “produce,” “determine,” and “select” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

### Example 1

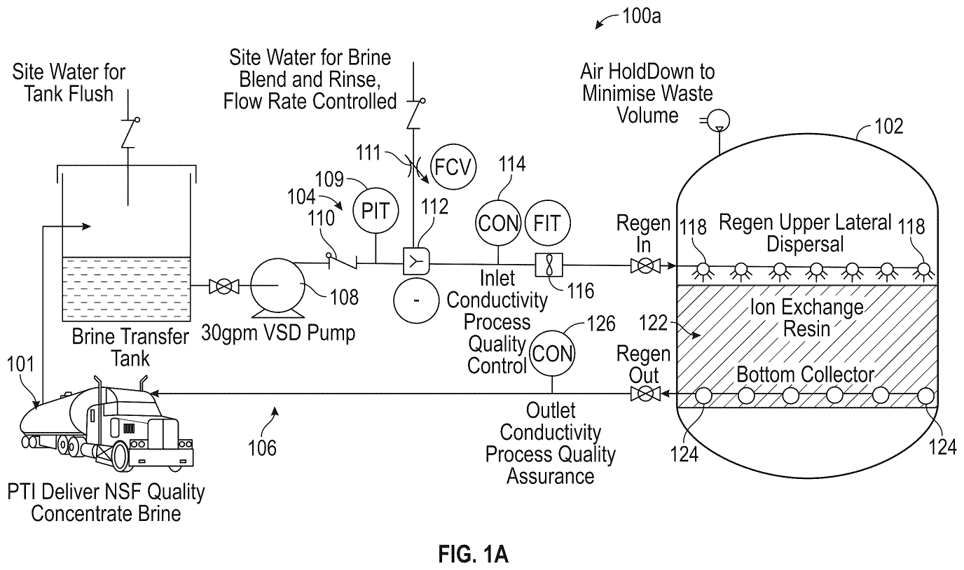

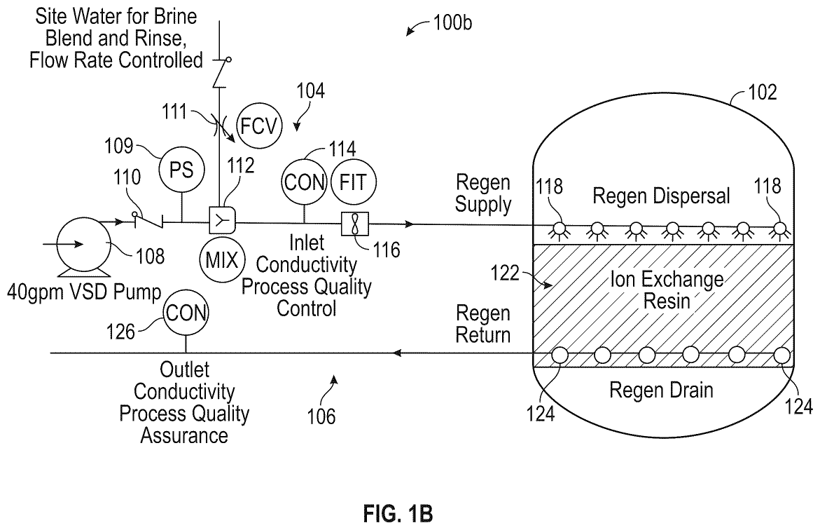

As depicted in FIGS. 1A-1B, in some examples, a system 100a, 100b for regenerating ion exchange resin can be intended for use with an ion exchanger 102 and can comprise a supply side 104 and a return side 106. The system 100a for regenerating ion exchange resin, comprises a vehicle 101, such as a semi-truck with a tanker trailer.

In some examples, the supply side can comprise a supply pump 108 and one or more valves such as a check valve 110 which are fluidly connected. In some examples, the pump 108 is a variable speed drive pump. The components of the supply side may serve to control direction of flow in the system. The supply side may also comprise a connection for supplying additional water to the system. In some examples, the additional water is supplied by a site water source and the flow of the site water can be controlled using flow control valve 111. The site water may be mixed with the brine at a mixer 112. In some examples, the brine that is supplied, for example, from a tank attached to a vehicle, can be 26% salt (e.g., NaCl), and can be mixed with site water and diluted to 12% salt.

One or more sensors may be used on the supply side to determine and control properties of the brine being supplied. In some examples, a conductivity meter may be used to measure the conductivity of the supplied brine, water, and/or mixture of brine and water. In the depicted example, the supply conductivity can be measured by conductivity meter 114. In some examples, the flow rate of the supply may be measured by one or more flow meters. In the depicted example, the flow rate of the supply side is measured by a turbine flow meter 116.

The ion exchanger (IX) may comprise a dispersal mechanism, a resin bed, and a system of one or more drains for draining the waste solution and directing it to the return side. The dispersal mechanism may comprise one or more nozzles 118. The resin bed 122 may comprise a strong base anion exchange resin. In some examples, the resin can be a gel polystyrene crosslinked with divinylbenzene with a type I quaternary ammonium functional group. In some examples, the resin can be an epoxy with a polyamine functional group. In some examples, the ion exchanger can remove impurities in well water. In some examples, the impurities can comprise chromium (i.e. Cr(VI)), arsenic, manganese, nitrates, sulfates, chlorides, uranium, cadmium, copper, lead, selenium, zinc, and/or vanadium. The drain system may comprise one or more drains 124 which direct the liquid waste solution to piping of the return side 106 of the system 100a, 100b.

The return side 106 of the system 100a, 100b may comprise one or more sensors. In some examples, the return side of the system may comprise a conductivity meter, which can be configured to measure the conductivity of the liquid waste solution. In the depicted example, the return conductivity is measured by conductivity meter 126. The return side of the system returns the waste solution to the tanks, such as the tank attached to the vehicle 101.

The table below is potential configurations of lead/lag filtration tanks that can be installed at customer well sites. Configuration and size can be dependent on water flow from the well. In some examples, lower flow rates may use the smaller diameter tanks.

| Rollup Regeneration Options | | 4 ft Diameter | 4 ft Diameter | 6 ft Diameter | 8 ft Diameter | 10 ft Diameter |
|---|---|---|---|---|---|---|
| Flow Rate | GPM | 50-100 | 100-200 | 175-400 | 300-700 | 475-1100 |
| Media per Vessel | cubic ft | 60 | 60 | 126 | 168 | 287 |
| Bed Volume | Gallons | 450 | 450 | 945 | 1,260 | 2,150 |
| Vessel | | Lead - Mid - Lag | 2 Parallel | Lead - Lag | Lead - Lag | Lead - Lag |
| Configuration | | | Lead - Lag | | | |
| Vessels in system | # | 3 | 4 | 2 | 2 | 2 |
| Vessels regenerated | # | 2 | 2 | 1 | 1 | 1 |
| Regeneration waste | Bed | 3.5 | 3.5 | 3.5 | 3.5 | 3.5* |
| | Volumes | | | | | |

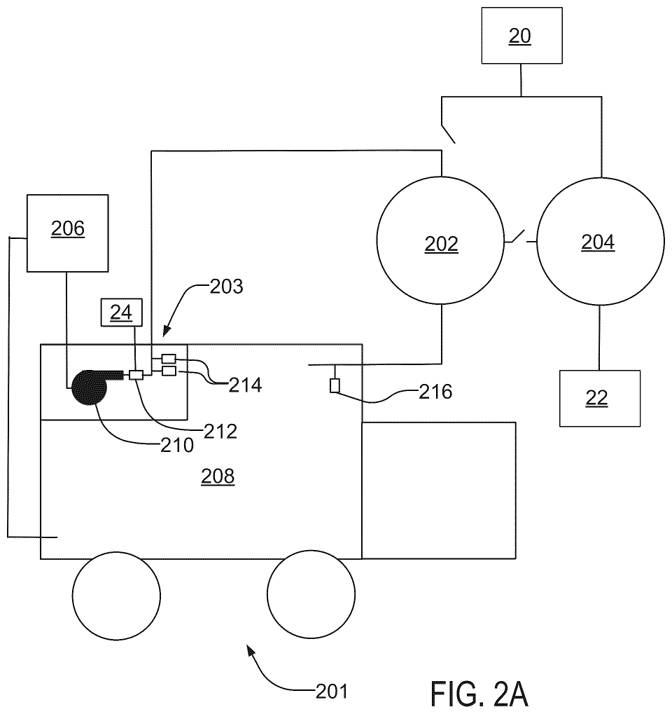

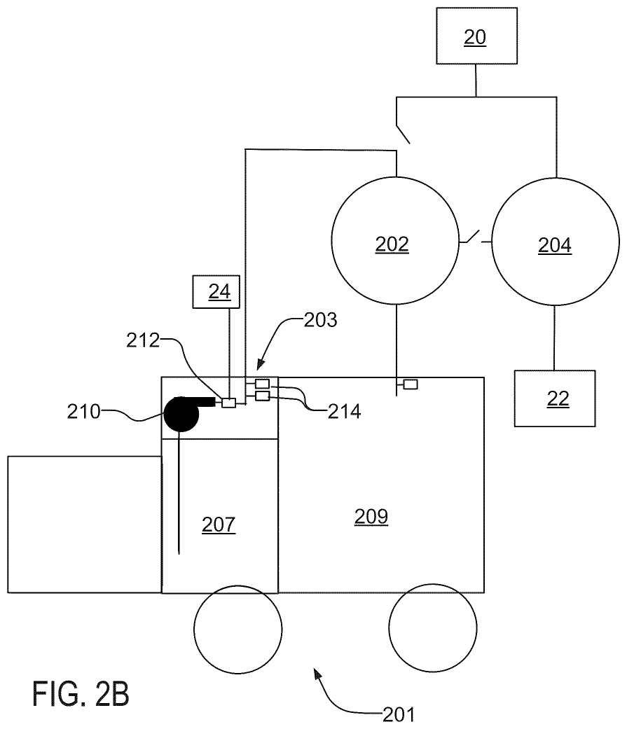

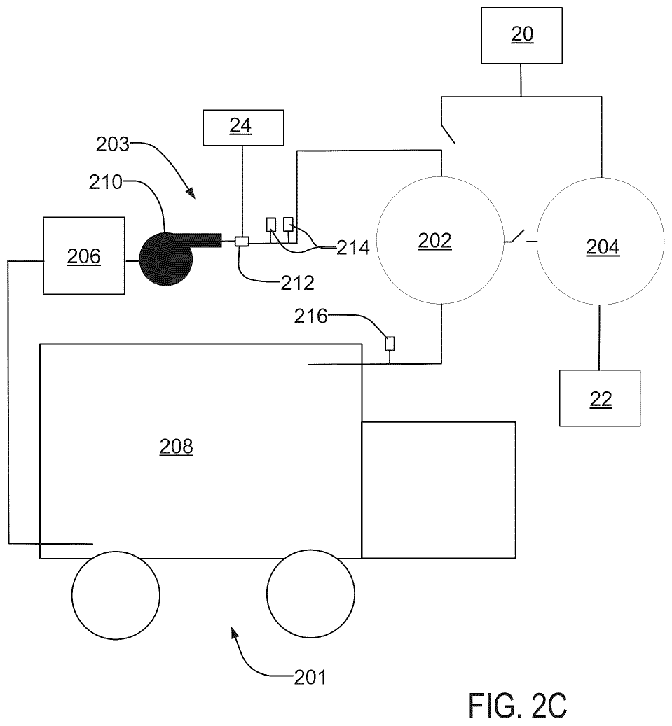

FIGS. 2A-2C depict different system setups for components which may be mounted on the vehicle and/or present at the site.

The depicted water purification systems include a lead/lag IX system. During normal operation, a lead/lag configuration uses at least two IXs online, in series. In a lead/lag system, during normal operation water from a water source 20 passes through the “lead” IX 202 first and then through the “lag” IX 204 second and then is delivered to the water supply header 22. The lead IX can be taken offline when for example, signs of breakthrough leakage (e.g., of hexavalent chromium or another substance) are detected, at a preset level of breakthrough leakage (e.g., 50% of inlet concentration), or at total exhaustion (inlet contaminant level equals outlet level). In some examples, the condition for taking the lead IX offline can be a predetermined number of bed volumes passing through the IX. In some examples, the predetermined number of bed volumes is based on studies which determine the number of bed volumes before the chrome starts to break through to the lag column. These studies may help set a setpoint as to when a regeneration is indicated. In some examples, sampling and testing of samples either online or offline may allow the maximum bed volume before regeneration to be adjusted. In some examples, an online measure (e.g., remote sensing) of hexavalent chromium at an outlet of the IX could also be used to trigger an alert that regeneration is indicated.

When one or more of the above conditions is met, the “lead” IX 202 can be taken offline for regeneration of the IX resin. For the regeneration process, the well water source 20 is switched to flow through the lag IX 204 alone. After the lead IX 202 has undergone the regeneration process, it is placed back online and becomes the new lag IX and the former lag tank becomes the new lead IX.

These systems may comprise some or all of the following components: a water source 20, a water supply header 22, a site water supply 24, a vehicle 201, a transfer tank 206, a pump 210, a mixer 212, one or more supply side sensors 214, one or more return side sensors 216, and conduits coupling the any of the above components in fluid communication in various arrangements. In some examples the supply side sensors 214 can comprise a conductivity meter and/or a flow meter. In some examples, the pump 210, the mixer 212, the one or more supply side sensors 214, and the one or more return side sensors 216 may be referred to together as a “regeneration station” 203.

In FIG. 2A, the brine in the tank 208 on the vehicle 201 is offloaded to a transfer tank 206 which is located at the site. The brine is then supplied from the transfer tank 206 for the regeneration process. In some examples, the brine comprises chlorides (e.g. sodium chloride). The regeneration station 203 can be located on the vehicle. The tank 208 is hooked up to receive the waste solution from the IX 202 which is being regenerated. In the example depicted in FIG. 2A, the customer does not need to have a regeneration station 203, and need only have a transfer tank 206 onsite.

In FIG. 2B, the vehicle 201 comprises a two-compartment tank where the fresh brine is supplied from the front compartment 207 and the spent brine will be loaded into the back compartment 209. This eliminates the need for the customer to have a transfer tank 206 on site. When the front compartment 207 is empty the final rinse can go back into to the front compartment 207. In some examples, the front compartment 207 and the back compartment 209 have different capacities. In one example, the front compartment 207 can hold 2,000 gallons and the back compartment 209 can hold 3,000 gallons. In the example depicted in FIG. 2B, the customer does not need to provide a regeneration station 203 or a transfer tank. For water well sites, which are often space constrained, this example may provide the benefit of requiring fewer on-site system components.

In FIG. 2C the transfer tank 206 and the regeneration station 203 are both located at the site and the vehicle supplies the concentrated brine to the transfer tank 206. In the example depicted in FIG. 2C, the customer would need to provide a regeneration station 203 and a transfer tank 206.

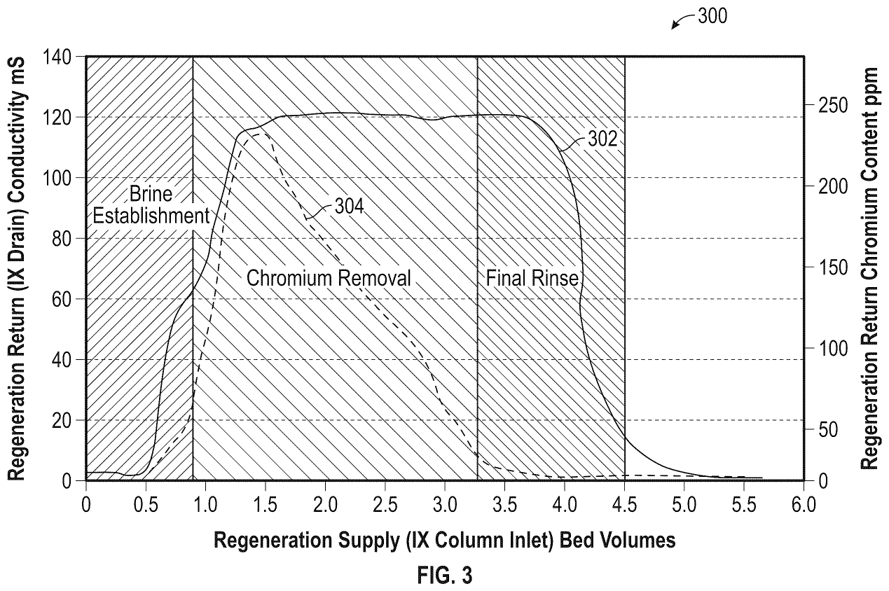

FIG. 3 is a graph 300 showing conductivity 302 and Cr(VI) content 304 of the waste solution as a function of the number of bed volumes of brine supplied. It should be understood from the graph that the Cr(VI) level will fall to an acceptable level after approximately 3 bed volumes have been supplied to and then removed from the IX resin bed.

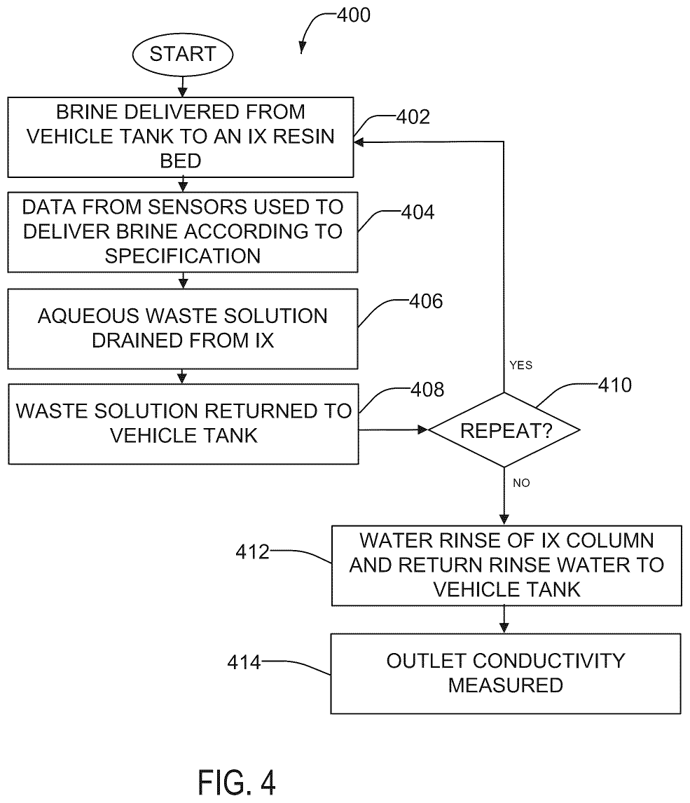

FIG. 4 depicts a method 400 of using the system for ion exchange equipment regeneration and waste management. In some examples, a strong base anion exchange resin, which has adsorbed hexavalent chromium from water as a part of the treatment of the water, can be regenerated. When the resin is close to saturation the resin needs to be either regenerated or replaced. One or more bed volumes of brine solution are used to flood the resin and push out the hexavalent chromium. The hexavalent chromium is collected in the spent brine (e.g., liquid waste solution) that is then returned to the vehicle tank. Additionally, a rinse with fresh water may be used after the last bed volume of brine. The one or more bed volumes of brine and the final rinse regenerate the IX resin. After the final rinse, the conductivity of the outlet can be measured to ensure that the rinse has been effective, and that the outlet water is now low enough in salt that the column can be returned to drinking water service.

At 402, the brine to an IX resin bed from a tank coupled to a vehicle. At 404, data from one or more sensors is used to deliver brine according to predetermined specifications. At 406, the waste solution is drained from the IX resin bed. At 408, the waste solution is returned to the vehicle tank. At 410, a determination is made whether additional bed volumes of brine are required. At 412, a final rinse of the IX column is conducted with rinse water and the rinse water is returned to the vehicle tank. At 414, the outlet conductivity is measured to ensure that the rinse has been effective, and the outlet water has a low enough salt content that the IX column can be placed back online.

### Example 2

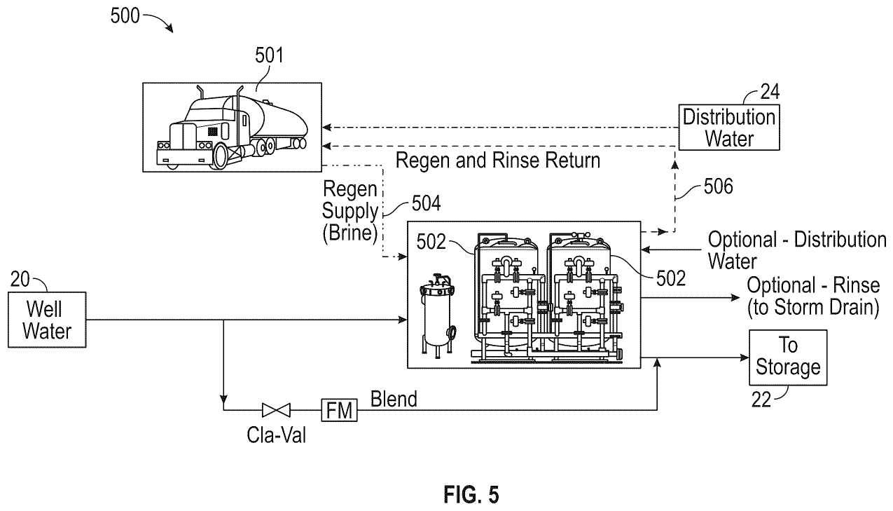

FIG. 5 depicts a system 500 for regenerating ion exchange resin which can be configured for use with an ion exchange column 502 (also referred to as an “ion exchanger”) and can comprise a supply side 504 and a return side 506. The system 500 for regenerating ion exchange resin can comprise a vehicle 501. In some examples, the vehicle 501 can comprise an unpowered trailer which is configured to be towed by a powered vehicle, for example a tanker trailer which can be towed by a semi-truck. The vehicle 501 can advantageously contain all of the components required to regenerate the ion exchange resin in the ion exchange column 502 of a water purification system and can be mobile so as to reduce the equipment and costs associated with operating and maintaining an ion exchange column. In some examples, after the regeneration process, an optional rinse can be sent to a storm drain.

The vehicle 501 of the system 500 can be used to deliver a regeneration solution to the ion exchange column 502. In some examples, ion exchange resins can be regenerated with chlorides or hydroxides. Examples of regeneration chemicals can include sodium chloride, potassium chloride, hydrochloric acid, sodium hydroxide, and/or potassium hydroxide. In some examples, the regeneration solution that is supplied can be a brine. In some examples, the brine can be a sodium chloride solution which can be 26% salt (e.g., NaCl) by weight. In some examples, the brine that is supplied can be in a range of 3% to 26.5% salt by weight, such as 5% to 26.5%, 10% to 26.5% 20% to 26.5% salt by weight, etc. One or more of the regeneration solutions listed above can be used to regenerate ion exchange resin contaminated with contaminants such as chromium, nitrates, sulfates, arsenic, uranium, selenium, vanadium, molybdenum, iron, and/or manganese.

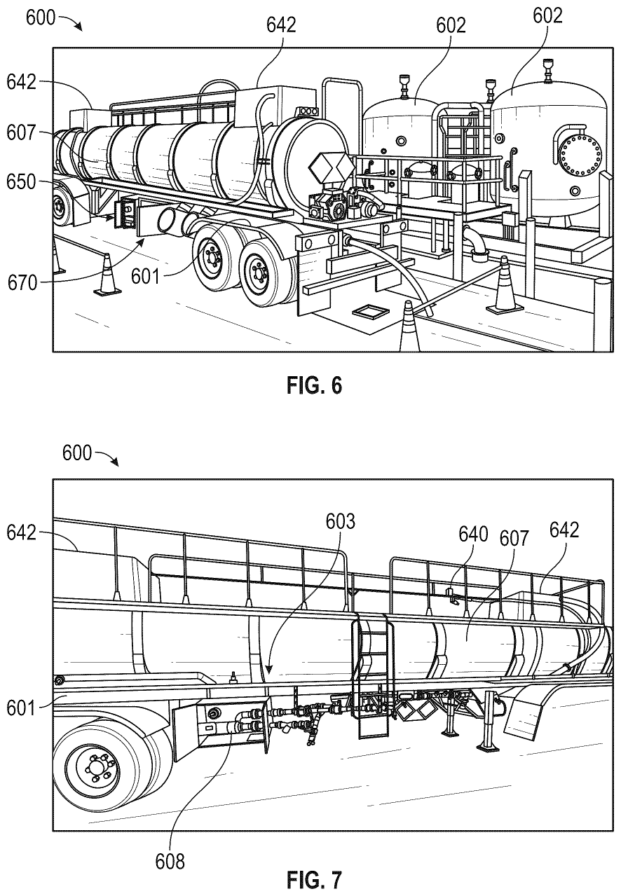

FIGS. 6-12 depict aspects of an exemplary system 600 for regenerating ion exchange resin which can be configured for use with an ion exchange column 602. In some examples, the system 600 can be similar to the other systems for regenerating ion exchange resin described herein. The system 600 can have the advantages of being mobile which can mean that the same system 600 can be used to regenerate multiple ion exchange columns. The system 600 can have the advantage that operators of ion exchange columns, such as for water purification, do not need to have dedicated resin regeneration equipment on site for their ion exchange columns. This can result in lower startup and maintenance costs. The system 600 can also have the advantage of removing the waste created by the regeneration process from the site following completion of the regeneration process which can reduce or eliminate the need for onsite hazardous waste tanks which can require frequent inspections.

FIG. 6 depicts a perspective view of the system 600 parked near an ion exchange column 602. The system 600 can comprise a vehicle 601 which can support other components such as a tank 607, a control system 650, a power unit 670, and a regeneration station 603 (FIG. 7). In the depicted example, the vehicle 601 is a semi-trailer. The system 600 can comprise conduits (e.g., pipes) arranged to place the tank 607 on the vehicle 601 in fluid communication with an ion exchange column 602. The system 600 can include on or more access ports which can be housed in an access dome 642. The access dome 642 can have openings which can be used to access the tank 607 (e.g., for filling, rinsing, and/or cleaning). In some examples the access domes 642 can be sized and shaped to act as roll cages to prevent puncture of the tank 607 if the vehicle and/or the trailer tips over.

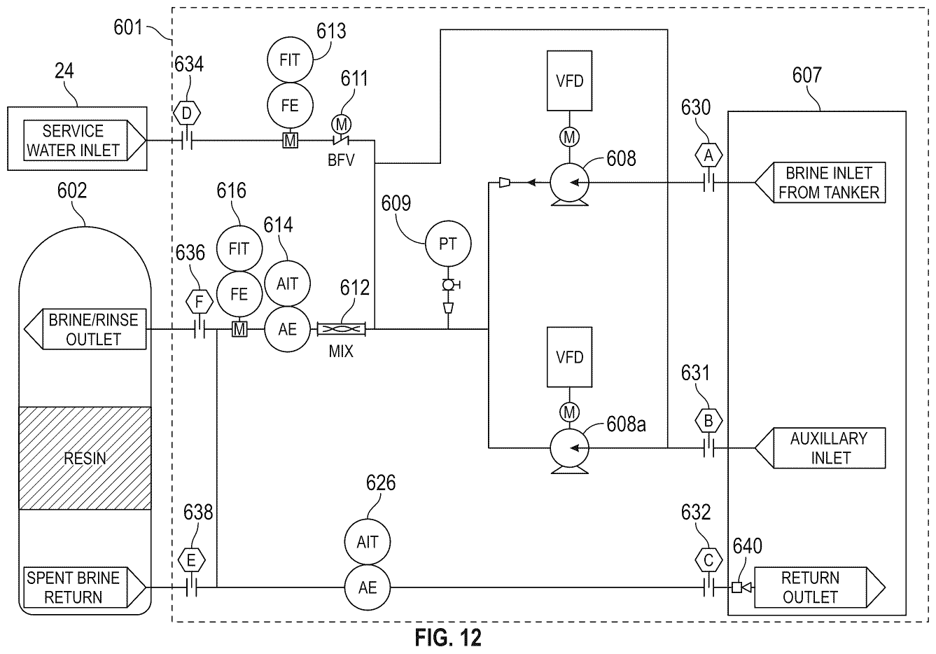

FIG. 7 depicts a side view of the system 600, including the vehicle 601, the tank 607, and components of the regeneration station 603. In some examples, the system 600 can comprise an eductor assembly 640. The eductor assembly 640 can be used to mix the solution in the tank 607 (e.g. the brine) with another liquid or solution, for example the water from the ion exchange column 602 at the start of the regeneration process. In some examples, the eductor assembly may be positioned within the tank 607. In some examples, as depicted in FIG. 12, the eductor assembly 640 can be fluidly coupled to the second connection 632 (described below). In some examples, the eductor assembly 640 can be fluidly coupled to the second connection 632 using a hose. In some examples, the eductor assembly 640 can be fluidly coupled to the second connection 632 using a pipe. The eductor assembly 640 can mix the water provided to the tank 607 from the ion exchange column 602 with the concentrated brine solution in the tank 607.

In some examples, the regeneration station can comprise a supply pump 608 which may, for example, be configured to supply brine from the tank 607 to the ion exchange column 602, return spent brine to the tanker, control direction of flow in the system, etc. In some examples, the pump 608 is a variable frequency drive pump. As depicted, the components of the regeneration station 603 can be positioned below the tank 607, which can have the advantages of conserving space and ensuring the regeneration station is easily accessible for operation and maintenance.

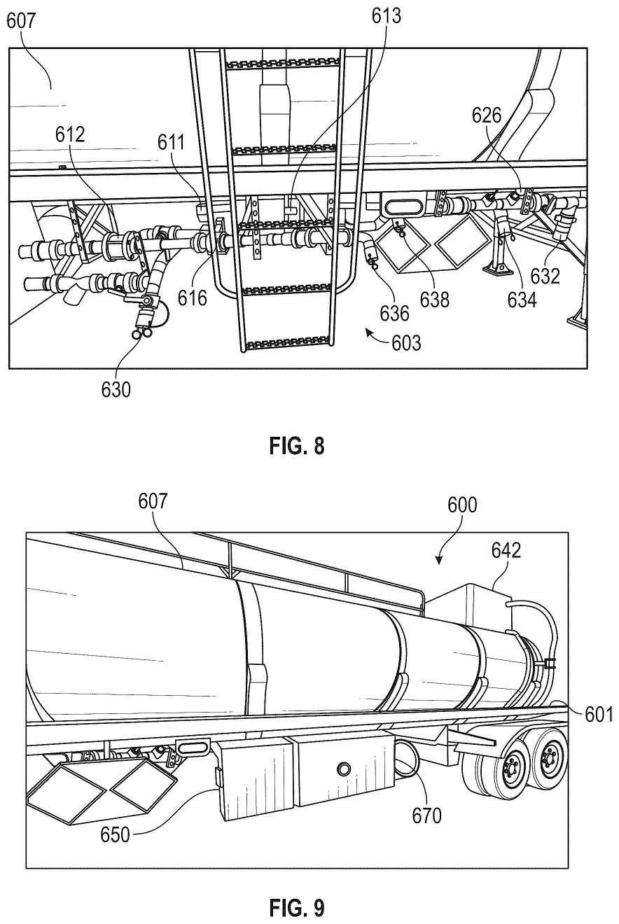

FIG. 8 depicts a closeup of some components of the system 600. The regeneration station 603 may also comprise one or more connections which can fluidly couple the regeneration station 603 to the tank 607, site water, and/or the ion exchange column. A first connection 630 (also referred to as a “brine inlet”) can be for connecting the regeneration station 603 to the tank 607. A second connection 632 (also referred to as a “return outlet”) can be configured to return brine and/or waste solution to the tank 607. A third connection 634 (also referred to as a “service water inlet”) can be configured to connect to site water (also referred to as “service water”) for supplying additional water to the system. In some examples, site water can be used to rinse the ion exchange resin after the regeneration process. The flow of the site water can be controlled using a flow control valve 611. In some examples, a flow meter 613 can measure the flow rate of site water. The site water may be mixed with the brine at a mixer 612, which can be downstream of the pumps 608 and 608a (FIG. 12) and the service water inlet connection 634, and upstream of the brine/rinse outlet connection 636. In some examples, the site water can used to control a level of water in the ion exchange column 602 prior to regeneration. In some examples, the water can be drained from the ion exchange column 602 prior to regeneration to achieve a predetermined level of water in the ion exchange column 602. In some examples, the water in the ion exchange column 602 prior to regeneration can be sent to the tank 607 to dilute the concentrated brine in the tank 607. In some examples, the site water can be used for a freshwater rinse of the ion exchange resin in the ion exchange column 602 after regeneration is completed.

A fourth connection 636 (also referred to as a “brine/rinse outlet”) can be configured to connect to the ion exchange column to supply brine to the ion exchange resin through a dispersal mechanism. In some examples, the dispersal mechanism may comprise one or more nozzles (which can be similar to nozzles 118 as depicted in FIGS. 1A-1B). A fifth connection 638 (also referred to as a “spent brine return”) can be configured to receive brine (e.g., spent brine) and/or waste solution from the ion exchange column. In some examples, the fifth connection 638 is configured to connect to a drain system of an ion exchange column. The drain system may be similar to the drain system depicted in FIGS. 1A-1B, and in some examples can comprise one or more drains 124 which direct the liquid waste solution to the fifth connection 638 of the regeneration station 603.

The regeneration station 603 may comprise one or more sensors which may be used to determine and control properties of the fluid, such as the brine and/or waste solution, in the system 600. A conductivity meter may be used to measure the conductivity of the supplied brine, site water, and/or the conductivity of a reduced salinity mixture of brine and water. In some examples, the flow rate of the supply (e.g., of brine) may be measured by one or more flow meters. In the depicted example, the flow rate of the supply side can be measured by a flow meter 616. In some examples, the return side of the system may comprise a conductivity meter, which can be configured to measure the conductivity of the liquid waste solution and/or of rinse water after the regeneration process. In the depicted example, the return conductivity is measured by conductivity meter 626 (also referred to as a “second conductivity meter”) which can measure the conductivity of the waste solution as it is returned to the tank 607 through the second connection 632. In some examples, the regeneration station 603 may comprise two conductivity meters positioned on the return side which can, for example, provide redundancy.

FIG. 9 depicts a side view of the system 600 including the vehicle 601, the tank 607, a control system 650 and a power unit 670. The control system 650 can be powered by the power unit 670 and can provide control signals to components of the regeneration station 603.

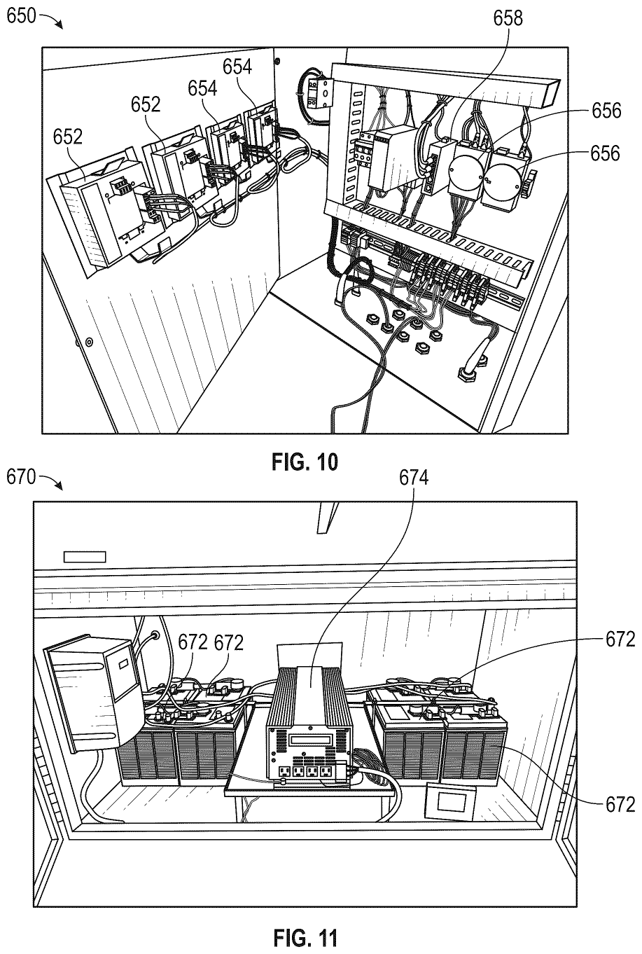

FIG. 10 depicts components of the control system 650. The control system can receive data from sensors and provide control signals to components of the regeneration station 603 such as valves, the pumps, etc. In some examples, the control system 650 can upload data from the sensors to remote data storage. For example, upload the sensor data to cloud storage via a wireless connection. In the depicted example the control system includes one or more flow meter transmitters 652 and one or more conductivity meter transmitters 654. The flow meter transmitters 652 can receive data signals from one or more flow meters within the regeneration station 603, for example the flow meter 613 and/or the flow meter 616. The conductivity meter transmitter 654 can receive data signals from one or more conductivity meters within the regeneration station 603, for example the conductivity meter 614 and/or the conductivity meter 626.

The control system 650 may comprise one or more data acquisition modules 656 and/or a network switch 658. The data acquisition modules 656 can receive data from the flow meter transmitters 652 and/or the conductivity meter transmitters 654 and can provide the data to a data storage or data communication device. The network switch 658 can connect multiple devices and allow data transfer between multiple components of the control system 650. In some examples, the control system 650 can share features with the computing environment 900 described below.

The control system 650 may comprise a programable logic controller (PLC) and may send control signals to one or more components in the regeneration station 603. The control system 650 sends control signals to components of the regeneration station 603 including the pump 608, an auxiliary pump 608a (FIG. 12), and/or the flow control valve 611 (FIG. 12). In some examples, the pump 608 and/or the auxiliary pump 608a can be variable speed pumps and the control system 650 can be used to control a speed setting of the pumps, and thus the flow rate produced by the pumps. Manipulating these components can control the flow of fluid through the regeneration station. In some examples, the control system 650 can be used by an operator to input commands for manual control of the regeneration station 603.

In some examples, the control system 650 can be used for automatic control of the regeneration station 603. The control system 650 can be used to automatically control regeneration of the ion exchange resin according any of the methods described herein, for example the method 700, describe below. In some examples, the control system 650 can be used to control flow of fluid through the system 600. In some examples, the control system 650 can be used to initiate a regeneration cycle which includes starting pump 608 and/or the auxiliary pump 608a which initiates brine flow from the tank 607 to the ion exchange column 602. The control system 650 can monitor the flow rate using the flow meter 613 and/or the flow meter 616 to determine the status of the regeneration process. The control system 650 can then initiate a freshwater rinse of the ion exchange column 602. In some examples, the freshwater rinse can continue until conductivity data from the conductivity sensor 626 reaches a predetermined conductivity level. In other words, the control system 650 may be configured to receive conductivity data from the conductivity meter 626 and stop a freshwater rinse when a conductivity of water exiting the ion exchange column reaches a predetermined level. In some examples, the predetermined conductivity level can be in a range of 0.05 microsiemens per centimeter (μS/cm) to 4,000 μS/cm, such as 0.5 μS/cm to 4,000 μS/cm, 500 μS/cm to 4,000 μS/cm, 1,000 μS/cm to 4,000 μS/cm, 0.5 μS/cm to 3,000 μS/cm, 500 μS/cm to 3,000 μS/cm, 1,000 μS/cm to 3,000 μS/cm, 0.5 μS/cm to 2,000 μS/cm, 500 μS/cm to 2,000 μS/cm, 1,000 μS/cm to 2,000 μS/cm, etc. In some examples, the predetermined level can be in a range of 0.5 μS/cm to 2,000 μS/cm. The control system can operate the pump, valves, and connections of the regeneration station 603 so that spent brine and rinse water are returned to the tank 607.

FIG. 11 depicts components of the onboard power supply 670. The onboard power supply 670 can comprise one or more batteries 672 and a power inverter 674. The power inverter 674 can convert direct current (DC) electricity into alternating current (AC) electricity. This can allow AC electronics to be powered from DC sources such as the one or more batteries 672. In some examples, the onboard power supply may have other inputs, for example a connection to site power and/or solar panels.

FIG. 12 is a schematic depiction of components of the system 600 for regenerating ion exchange resin of FIGS. 6-11. The vehicle 601 is represented by a dashed line and the tank 607 is depicted by a box drawn in solid lines. The diagram includes the ion exchange column 602, the pump 608, the auxiliary pump 608a, the mixer 612, the flow control valve 611, the flow meter 613, a conductivity meter 614 (also referred to as a “first conductivity meter”), the flow meter 616, and the conductivity meter 626. The system 600 includes a pressure sensor 609 which can be similar to the pressure sensor 109 as depicted in FIGS. 1A-1B. In some examples, the supply side of the system may comprise a conductivity meter, which can be configured to measure the conductivity of the brine being supplied to the ion exchange resin. In the depicted example, the supply conductivity is measured by conductivity meter 614, which can measure the conductivity of the brine solution before it is supplied to the ion exchange column 602 through the fourth connection 636.

The connections of the regeneration station 603 are also depicted. These connections can fluidly couple the regeneration station 603 to the tank 607, site water 24, and/or the ion exchange column 602 in various combinations as the regeneration process progresses. The first connection 630 can fluidly couple the regeneration station 603 to the tank 607 and can be fluidly coupled to the inlet of the pump 608. An auxiliary connection 631 can fluidly couple the regeneration station 603 to the tank 607 and can be fluidly coupled to the inlet of the auxiliary pump 608a. The second connection 632 can be configured to return brine and/or waste solution to the tank 607. The third connection 634 can be configured to connect to site water for supplying additional water to the system. The fourth connection 636 can be configured to connect the regeneration station 603 to the ion exchange column 602 to supply brine to the ion exchange column. The fifth connection 638 can be configured to receive brine and/or waste solution from the ion exchange column 602.

As depicted, the pump 608 and the auxiliary pump 608a are downstream of the first connection 630 and the auxiliary connection 631, respectively. The pressure sensor 609 can be down stream of the pump 608 and the auxiliary pump 608a. The mixer 612 can be downstream of the pump 608 and the auxiliary pump 608a. The mixer 612 can also be downstream of the third connection 634, and upstream of and in fluid communication with, the fourth connection 636. The flow control valve 611 and the flow meter 613 can be downstream of the third connection 634 and upstream of the mixer 612. The flow meter 616 can be downstream of the mixer 612 and upstream of the fourth connection 636. The conductivity meter 626 can be downstream of the third connection 634 and upstream of the second connection 632. The various pipes coupling the components of the regeneration station 603 together are represented as lines. The system can include a variety of additional valves, instruments, sensors, etc., in addition to those shown in FIG. 12.

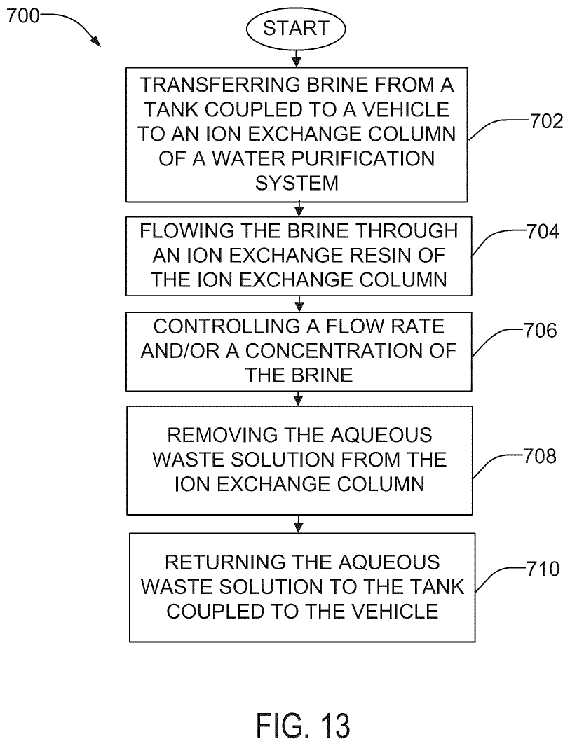

FIG. 13 depicts a method 700 of using a system, for example the system 600, for ion exchange resin regeneration. At, block 702 brine is transferred from a tank 607 coupled to a vehicle 601 to an ion exchange column 602 of a water purification system. At block 704, the brine is flowed through an ion exchange resin of the ion exchange column 602. The brine regenerates the resin by removing one or more impurities resulting in an aqueous waste solution. At block 706 the flow rate and/or a concentration of the brine is controlled. At block 708 the aqueous waste solution is removed from the ion exchange column. At block 710, the aqueous waste solution is returned to the tank 607 coupled to the vehicle 601.

In some examples, the regeneration process can be conducted without a transfer tank. A tank with fully saturated brine solution of ≥24% salt (e.g., NaCl) by weight can be delivered to the ion exchange column that is being regenerated, for example with a vehicle 601 such as a tanker. Brine at a first brine concentration, for example fully saturated brine, is pushed (e.g., pumped) from the tank and can be mixed, for example with site water, resulting in brine at a second brine concentration, for example a blended brine with reduced strength. In other words, the brine in the tank comprises a first brine concentration which can be diluted, for example with site water, to result in a second brine concentration. The brine at the second brine concentration can be supplied to the ion exchange resin where it extracts contaminants from the resin to regenerate the ion exchange resin. In some examples, the first brine concentration can be 20% to 26.5% salt by weight, such as 23% to 26.5% salt by weight. In some examples, the second brine concentration can be 10% to 15% salt by weight, such as 12% salt by weight. The first and second brine concentrations can have any of the values given herein.

In some examples, the water level in the ion exchange column 602 before the start of regeneration can be lowered so that the water is above the resin level (e.g. 1 cm to 20 cm above the resin level). This liquid level in the column can be maintained during the regeneration process. In some examples, the water can be removed from the ion exchange column 602 by air pressure and/or gravity and can be drained to the water supply header of the drinking water distribution system prior to the start of the regeneration. In some examples, after the water level is lowered so that the water is above the resin level, brine can be supplied to the ion exchange column 602 with the pumps of the regeneration station 603. In some examples, brine from the tank 607 can push the water in the ion exchange column 602 out of the ion exchange column 602 and into the tank 607. In some examples, the water removed from the ion exchange column 602 prior to regeneration can be mixed with the saturated brine in the tank 607. After the brine has pushed out most of the water in the ion exchange column 602, the regeneration station 603 can be manipulated such that the liquid coming from the ion exchange column 602 can be returned to the tank 607 as aqueous waste, for example, sent to a waste tank, returned to the tank 607 once it is empty of brine, or in examples in which the tank 607 comprises multiple compartments (see, e.g., FIG. 2B) the aqueous waste can be directed to a waste compartment of the tank 607.

In some examples, the brine at the first concentration can be mixed with water from the ion exchange column 602 at the start of the regeneration to dilute the concentrated brine in the tank 607. In some examples, the initial volume of concentrated brine in the tank 607 can be less than the total tank volume, such as 30% to 90% of the tank volume, 30% to 80% of the tank volume, 30% to 75% of the tank volume, 30% to 60% of the tank volume, etc. This can reserve volume in the tank for rinse water and/or aqueous waste from the regeneration process.

The conductivity of water flowing out of the ion exchange column (e.g., into the tank 607 through the second connection 632) can be measured (e.g., with the conductivity meter 626) to determine the salt content. After passing through the resin, the “spent” brine (also referred to as an “aqueous waste solution”) can be returned to the tanker through the regeneration station.

After the brine is pumped through the ion exchange resin, the system can be rinsed with fresh water. In some examples, during a rinse, the control system can determine whether the outlet water has a low enough salt content (as indicated by the conductivity reading) that the IX column can be placed back online. If the conductivity, and thereby the outlet water salt content, is within specified limits, the operator and/or the control system can place the regenerated ion exchange column back in service. In some examples, the specified conductivity can be 0.5 μS/cm to 2,000 μS/cm as noted above. In some examples, any or all of the steps above can be performed by the control system 650. In some examples, after the regeneration process, an optional rinse can be sent to a storm drain

Once the regeneration process is complete the tank 607 now contains hazardous waste. The hazardous waste can be sent to a Treatment, Storage and Disposal facility (TSDF) which can weigh the tank and vehicle full of aqueous waste solution, offload the aqueous waste solution, and weigh the vehicle and empty tank to obtain a weight of the aqueous waste solution. The tank can then be emptied and rinsed. The tank can be sanitized and made ready for loading with brine.

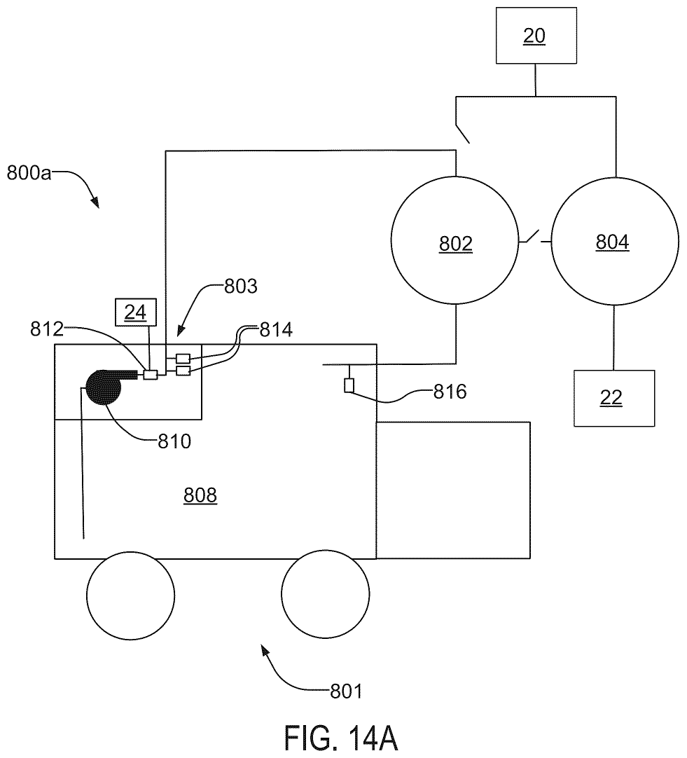

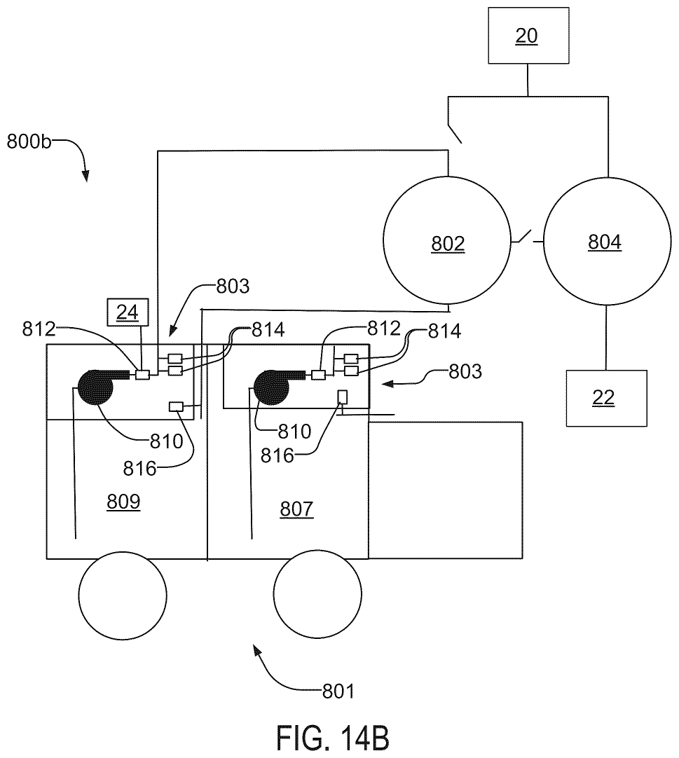

FIGS. 14A-14B depict examples of systems 800a, 800b which can share features with the systems depicted in FIGS. 2A-2C. For example, systems 800a, 800b comprise components which may be mounted on the vehicle and/or present at the site. For example, the systems 800a, 800b can comprise some or all of the following components: a water source 20, a water supply header 22, a site water supply 24, a vehicle 801, one or more pumps 810, one or more mixers 812, one or more supply side sensors 814, one or more return side sensors 816, and conduits coupling any of the above components in fluid communication in various arrangements. In some examples the systems 800a, 800b may omit transfer tank. In some examples the supply side sensors 814 and/or the return side sensors 816 can comprise a conductivity meter and/or a flow meter. In some examples, the pump 810, the mixer 812, the one or more supply side sensors 814, and the one or more return side sensors 816 may be referred to together as a “regeneration station” 803.

The depicted systems 800a, 800b are configured to be used with water purification systems include lead/lag water ion exchange columns. As depicted, a “lead” ion exchange column 802 can be taken offline for regeneration of the IX resin. For the regeneration process, the well water source 20 is switched to flow through a lag ion exchange column 804 alone. After the lead ion exchange column 802 has undergone the regeneration process, it can be placed back online and becomes the new lag IX and the former lag tank becomes the new lead IX.

FIG. 14A depicts the system 800a which can be similar to the system depicted in FIG. 2A with the exception that the system 800a omits the transfer tank. The tank 808 can hold approximately 4700 gallons of brine or spent brine. The system 800a is designed to be used with 6 ft, 8 ft, and 10 ft diameter vessels. In use, the system 800a is delivered to the ion exchange column being regenerated with a tank 808 containing a fully saturated brine solution of ≥24% salt brine by weight. The level of water in the ion exchange column 802 can be controlled, for example, by removing some water prior to regeneration.

In some examples, the water level before the start of regeneration can be lowered so that the water is above the resin level (e.g. 1 cm to 20 cm above the resin level). This liquid level in the column can be maintained during the regeneration process. In some examples, water can be removed from the ion exchange column 802 by air pressure and/or gravity and can be drained to the water supply header 22 of the drinking water distribution system prior to the start of the regeneration process. In some examples, after the water level is lowered so that the water is above the resin level, brine can be supplied to the ion exchange column 802 with the pumps of the regeneration station 803. In some examples, brine from the tank 808 can push the water in the ion exchange column 802 out of the ion exchange column 802 and into the tank 808. After the brine has pushed out most of the water in the ion exchange column 802, the regeneration station 803 can be manipulated such that the liquid coming from the ion exchange column 802 can be treated as aqueous waste, for example sent to a waste tank, returned to the tank 808 once it is empty of brine, or in examples in which the tank 808 comprises multiple compartments (see e.g. FIG. 2B) the aqueous waste can be directed to a waste compartment of the tank 808.

In some examples, the water removed from the ion exchange column 802 prior to regeneration can be mixed with the saturated brine in the tank 808. As the regeneration process starts, brine from the tank 808 can be combined with another source of water, such as site water, which can blend with the saturated brine. By eliminating the need for a transfer tank, the system 800a can reduce costs and make regeneration easier for the operator. The system 800a can be used with the method 700, described above and depicted in FIG. 13.

FIG. 14B depicts the system 800b which has two sides (also referred to as two portions) and can be used to regenerate smaller IX columns. In other words, the system 800b includes a tank which is divided into two portions and each portion is configured to be selectively fluidly coupled to the ion exchange resin of the ion exchange column. System 800b comprises dual tanks, a first tank 807 and a second tank 809, this dual tank system may work well to regenerate 2 ft, 3 ft, 4 ft, and 6 ft ion exchange columns. In some examples, the first tank 807 can be 1300 gallons, and the second tank 809 can be 2400 gallons. In some examples, there are two separate tanks end to end. In some examples, a barrier separates the two sides of the tank. In some examples, each of the first tank 807 and second tank 809 has its own regeneration station 803. In some examples, the first tank 807 and second tank 809 can share one regeneration station 803 which can be configured to selectively interface with the ion exchange column (e.g., the regeneration station 803 can place the first tank 807 and/or the second tank 809 in fluid communication with the ion exchange column). In some examples, the pumps 810 and the corresponding piping and hoses could be sized smaller to better fit the pumping rates and volumes of the smaller vessels being regenerated. The system 800b with a dual tank can have the advantage of being smaller and more maneuverable on smaller sites. It may also have the advantage of making it possible to regenerate vessels from two different sites in the same trip.

### Example 3: Representative Computing Environment

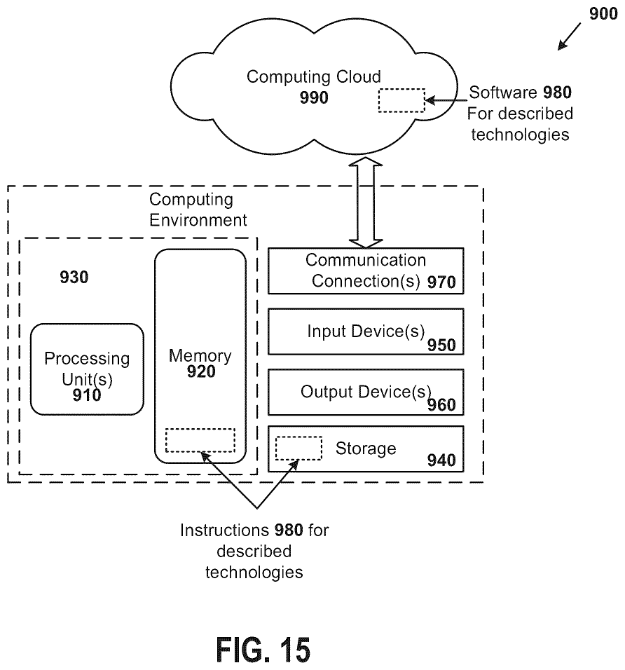

FIG. 15 illustrates a generalized example of a computing environment 900 in which software and control algorithms for the described examples can be implemented. For example, software and/or hardware for implementing the various control systems and flow controls described herein can be configured similarly to the computing environment 900, and can be a local computing system integrated as part of the regeneration station or can be a remote computing system as described herein.

The computing environment 900 is not intended to suggest any limitation as to scope of use or functionality of the technology, as the technology may be implemented in diverse general-purpose or special-purpose computing environments. For example, the disclosed technology may be implemented with other computer system configurations, including programmable automation controllers, programmable logic controllers, application-specific integrated circuits (ASICs), field-programmable gate arrays (FPGAs), hand held devices, multi-processor systems, programmable consumer electronics, network PCs, minicomputers, and the like. The disclosed control methodology may also be practiced in distributed computing environments where tasks are performed by remote processing devices that are linked through a communications network. In a distributed computing environment, program modules may be located in both local and remote memory storage devices.

With reference to FIG. 15, the computing environment 900 includes at least one processing unit 910 and memory 920. In FIG. 15, this most basic configuration is included within a dashed line. The processing unit 910 executes computer-executable instructions and may be a real or a virtual processor. In a multi-processing system, multiple processing units execute computer-executable instructions to increase processing power and as such, multiple processors can be running simultaneously. The memory 920 may be volatile memory (e.g., registers, cache, RAM), non-volatile memory (e.g., ROM, EEPROM, flash memory, etc.), or some combination of the two. The memory 920 stores software 980 that can, for example, implement the technologies described herein. A computing environment may have additional features. For example, the computing environment 900 includes storage 940, one or more input devices 950, one or more output devices 960, and one or more communication connections 970. An interconnection mechanism (not shown) such as a bus, a controller, or a network, interconnects the components of the computing environment 900. Typically, operating system software (not shown) provides an operating environment for other software executing in the computing environment 900, and coordinates activities of the components of the computing environment 900.

The storage 940 may be removable or non-removable, and includes non-volatile solid state memory, magnetic disks, or any other medium which can be used to store information and that can be accessed within the computing environment 900. The storage 940 stores instructions for the software 980, plugin data, and messages, which can be used to implement technologies described herein.

The input device(s) 950 may be, for example, a conductivity meter, a flow meter, a temperature sensor, a pressure sensor, or a touch input device such as a keyboard, keypad, mouse, touch screen display, pen, or trackball, a voice input device, a scanning device, or another device, that provides input to the computing environment 900. The output device(s) 960 may be a wired or wireless signal transmitter, a display, or another device that provides output from the computing environment 900.

The communication connection(s) 970 enable communication over a communication medium (e.g., a connecting network) to devices or computing entities. The communication medium conveys information such as control signals, computer-executable instructions, sensor inputs or outputs, or other data in a modulated data signal. The communication connection(s) 970 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed controlled devices.

Some embodiments of the disclosed methods can be performed using computer-executable instructions implementing all or a portion of the disclosed technology in a computing cloud 990 or other remote computing system. For example, the disclosed methods can be executed on processing units 910 located in the computing environment 930, or the disclosed methods can be executed on servers located in the computing cloud 990.

Computer-readable media are any available media that can be accessed within a computing environment 900. By way of example, and not limitation, with the computing environment 900, computer-readable media include memory 920 and/or storage 940. As should be readily understood, the term computer-readable storage media includes the media for data storage such as memory 920 and storage 940, and not transmission media such as modulated data signals.

### Additional Examples of the Disclosed Technology

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A system, comprising: a vehicle comprising a tank; and a regeneration station comprising one or more components including a pump, valves, and conduits arranged to place the tank on the vehicle in fluid communication with an ion exchange column of a water purification system; wherein the regeneration station is configured to supply a brine from the tank to the ion exchange column and return a liquid waste solution from the ion exchange column to the tank.

Example 2. The system of any example herein, particularly example 1, wherein the regeneration station is mounted on the vehicle.

Example 3. The system of any example herein, particularly example 1, wherein the regeneration station further comprises a conductivity meter.

Example 4. The system of any example herein, particularly example 3, wherein the conductivity meter is configured to measure the conductivity of the brine supplied to the ion exchange column.

Example 5. The system of any example herein, particularly example 3, wherein the conductivity meter is a first conductivity meter, and the system further comprises a second conductivity meter configured to measure the conductivity of the liquid waste solution.

Example 6. The system of any example herein, particularly example 4, wherein the regeneration station comprises a brine/rinse outlet connection configured to place the regeneration station in fluid communication with an inlet of the ion exchange column and wherein the conductivity meter is upstream of the brine/rinse outlet connection.

Example 7. The system of any example herein, particularly example 5, wherein: the regeneration station further comprises a spent brine return connection configured to place the regeneration station in fluid communication with an outlet of the ion exchange column; the regeneration station further comprises a brine return outlet connection configured to place the regeneration station in fluid communication with the tank; and the second conductivity meter is downstream of the spent brine return connection and upstream of the brine return outlet.

Example 8. The system of any example herein, particularly example 1, wherein the regeneration station further comprises one or more flow meters.

Example 9. The system of any example herein, particularly example 1, wherein the regeneration station further comprises a mixer configured to mix site water with brine at a first concentration to result in brine at a second concentration.

Example 10. The system of any example herein, particularly example 9, wherein the mixer is downstream of a service water inlet connection configured to connect to site water and downstream of a pump configured to draw brine from the tank.

Example 11. The system of any example herein, particularly example 10, wherein the mixer is upstream of and in fluid communication with a brine outlet of the regeneration station, the brine outlet being configured to supply brine at the second concentration to the ion exchange column.

Example 12. The system of any example herein, particularly example 1, wherein the tank is divided into two portions, each portion configured to selectively interface with the regeneration station.

Example 13. The system of any example herein, particularly example 3, further comprising a control system configured to control the one or more components of the regeneration station, wherein the control system is configured to receive conductivity data from the conductivity meter and stop a freshwater rinse when a conductivity of water exiting the ion exchange column reaches a predetermined level.

Example 14. The system of any example herein, particularly example 7, further comprising an eductor assembly downstream of the brine return outlet.

Example 15. A method, comprising: transferring brine from a tank coupled to a vehicle to an ion exchange column of a water purification system; flowing the brine through an ion exchange resin of the ion exchange column, wherein the brine regenerates the resin by removing one or more impurities resulting in an aqueous waste solution; controlling a flow rate and/or a concentration of the brine; removing the aqueous waste solution from the ion exchange column; and returning the aqueous waste solution to the tank coupled to the vehicle.

Example 16. The method of any example herein, particularly example 15, wherein the one or more impurities comprises hexavalent chromium.

Example 17. The method of any example herein, particularly example 15, wherein the brine comprises a sodium chloride solution.

Example 18. The method of any example herein, particularly example 15, wherein the brine in the tank comprises a first brine concentration, and the method further comprises mixing water with the brine at the first brine concentration until the brine comprises a second brine concentration that is lower than the first brine concentration.

Example 19. The method of any example herein, particularly example 18, wherein the first brine concentration is in a range of 20% to 26.5% sodium chloride by weight, and wherein the second brine concentration is in a range of 10% to 20% sodium chloride by weight.

Example 20. The method of any example herein, particularly example 18, wherein the brine at the second brine concentration is supplied to the ion exchange column.

Example 21. The method of any example herein, particularly example 15, wherein transferring brine from the tank coupled to the vehicle to the ion exchange column comprises transferring the brine with a regeneration station which comprises one or more components including a pump, valves, and conduits arranged to place the tank on the vehicle in fluid communication with an ion exchange column.

Example 22. The method of any example herein, particularly example 15, further comprising rinsing the resin with fresh water until water exiting the ion exchange column comprises a predetermined conductivity.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

We claim:

1. A system, comprising:
a vehicle comprising a tank; and
a regeneration station comprising one or more components including a pump, valves, and conduits arranged to place the tank on the vehicle in fluid communication with an ion exchange column of a water purification system;
wherein the regeneration station is configured to supply a brine from the tank to the ion exchange column and return a liquid waste solution from the ion exchange column to the tank.

2. The system of claim 1, wherein the regeneration station is mounted on the vehicle.

3. The system of claim 1, wherein the regeneration station further comprises a conductivity meter.

4. The system of claim 3, wherein the conductivity meter is configured to measure the conductivity of the brine supplied to the ion exchange column.

5. The system of claim 3, wherein the conductivity meter is a first conductivity meter, and the system further comprises a second conductivity meter configured to measure the conductivity of the liquid waste solution.

6. The system of claim 4, wherein the regeneration station comprises a brine/rinse outlet connection configured to place the regeneration station in fluid communication with an inlet of the ion exchange column and wherein the conductivity meter is upstream of the brine/rinse outlet connection.

7. The system of claim 5, wherein:
the regeneration station further comprises a spent brine return connection configured to place the regeneration station in fluid communication with an outlet of the ion exchange column;
the regeneration station further comprises a brine return outlet connection configured to place the regeneration station in fluid communication with the tank; and
the second conductivity meter is downstream of the spent brine return connection and upstream of the brine return outlet.

8. The system of claim 1, wherein the regeneration station further comprises one or more flow meters.

9. The system of claim 1, wherein the regeneration station further comprises a mixer configured to mix site water with brine at a first concentration to result in brine at a second concentration.

10. The system of claim 9, wherein the mixer is downstream of a service water inlet connection configured to connect to site water and downstream of a pump configured to draw brine from the tank.

11. The system of claim 10, wherein the mixer is upstream of and in fluid communication with a brine outlet of the regeneration station, the brine outlet being configured to supply brine at the second concentration to the ion exchange column.

12. The system of claim 1, wherein the tank is divided into two portions, each portion configured to selectively interface with the regeneration station.

13. The system of claim 3, further comprising a control system configured to control the one or more components of the regeneration station, wherein the control system is configured to receive conductivity data from the conductivity meter and stop a freshwater rinse when a conductivity of water exiting the ion exchange column reaches a predetermined level.

14. The system of claim 7, further comprising an eductor assembly downstream of the brine return outlet.

15. A method, comprising:
transferring brine from a tank coupled to a vehicle to an ion exchange column of a water purification system;
flowing the brine through an ion exchange resin of the ion exchange column, wherein the brine regenerates the resin by removing one or more impurities resulting in an aqueous waste solution;
controlling a flow rate and/or a concentration of the brine;
removing the aqueous waste solution from the ion exchange column; and
returning the aqueous waste solution to the tank coupled to the vehicle.

16. The method of claim 15, wherein the one or more impurities comprises hexavalent chromium.

17. The method of claim 15, wherein the brine comprises a sodium chloride solution.

18. The method of claim 15, wherein the brine in the tank comprises a first brine concentration, and the method further comprises mixing water with the brine at the first brine concentration until the brine comprises a second brine concentration that is lower than the first brine concentration.

19. The method of claim 18, wherein the first brine concentration is in a range of 20% to 26.5% sodium chloride by weight, and wherein the second brine concentration is in a range of 10% to 20% sodium chloride by weight.

20. The method of claim 18, wherein the brine at the second brine concentration is supplied to the ion exchange column.

21. The method of claim 15, wherein transferring brine from the tank coupled to the vehicle to the ion exchange column comprises transferring the brine with a regeneration station which comprises one or more components including a pump, valves, and conduits arranged to place the tank on the vehicle in fluid communication with an ion exchange column.

22. The method of claim 15, further comprising rinsing the resin with fresh water until water exiting the ion exchange column comprises a predetermined conductivity.
